(19) United States
(12) Patent Application Publication
(10) Pub. No.: US 2015/0068487 A1
(43) Pub. Date: Mar. 12, 2015

(54) PISTON OF AN INTERNAL COMBUSTION ENGINE

(71) Applicant: Caterpillar Energy Solution GmbH, Mannheim (DE)

(72) Inventors: Robert Böwing, Innsbruck (AT); Steffen Gruber, Edingen-Neckarhausen (DE); Manfred Rapp, Ubstadt-Weiher (DE); Gustav Schaller, Mannheim (DE)

(73) Assignee: Caterpillar Energy Solution GmbH, Mannheim (DE)

(21) Appl. No.: 14/391,371

(22) PCT Filed: Apr. 12, 2013
(86) PCT No.: PCT/EP2013/001088

§ 371 Date: Oct. 8, 2014

(30) Foreign Application Priority Data
Apr. 13, 2012 (DE) 102012103193.2

(51) Int. Cl. F02B 23/08; F02F 3/16

(52) U.S. Cl. CPC F02B 23/08; F02F 3/16
USPC 123/193.6

(57) ABSTRACT

A piston of an internal combustion engine is disclosed. The piston may have a piston sleeve with a centre axis and a piston base with a diameter D delimiting the piston sleeve at a top of the piston sleeve. The piston base may have a piston base rim of width b and a piston bowl with a depth t. The piston bowl may be designed as a pot bowl, which may have a piston bowl base and a piston bowl wall with a maximum diameter d4 adjoining the piston bowl base. The piston bowl may have an opening cross-section aligned symmetrically relative to the centre axis. The opening cross-section may have a minimum diameter da, which is smaller than the diameter d4. A flow cut-off edge designed as a nose may be formed in the opening cross-section and may project in the radial direction inwards over the piston bowl wall.

### BACKGROUND

The present disclosure relates to a piston of an internal combustion engine with a piston sleeve having a centre axis M, and a piston base with a diameter D delimiting the piston sleeve at the top, wherein the piston base is formed from a piston base rim of width b and a piston bowl with a depth t, wherein the piston bowl is formed as a pot bowl and has a piston bowl base as well as a piston bowl wall of diameter d4 adjoining same, and the piston bowl has an opening cross-section A which is aligned symmetrically relative to the centre axis M and has a diameter da which is smaller than the diameter d4 and through the reduced diameter da a flow cut-off edge designed as a nose is formed in the area of the opening cross-section A wherein the nose projects inwards in the radial direction over the piston bowl wall.

The present disclosure further relates to a use of a piston having a centre axis M and a piston base which is formed from a piston base rim and a piston bowl wherein the piston bowl is designed as a pot bowl and has a piston bowl wall with a maximum diameter d4 adjoining a piston bowl base.

### BACKGROUND

From DE 33 02 427 C2 a piston is known for a diesel engine having a pot-shaped piston bowl. A sharp edge is provided in the transition area between the opening cross-section and the wider piston bowl wall.

A similar design is also known from DE 31 15 933 A1 for diesel engines wherein the collar web comprising the edge causes a vortex current inside the piston bowl which counteracts the fuel rising up at the wall.

With Otto gas engines pistons are used which have various different piston bowl shapes. As a rule a difference is drawn between the following usual variations:

A) Pistons with roof-shaped piston base. The piston base is configured for combustion processes with a gas-flushed precombustion chamber so that the flare jets strike the combustion chamber walls as late as possible.

B) Pistons with trough-shaped piston base. The piston base is configured so that a tumble flow generated on the inlet side is maintained.

C) Pistons with omega piston bowl. The piston base is designed for diesel operation for optimum direct injection and is also used unchanged with the gas Otto engine. The latter for reasons of costs and simplicity, but quite possibly with a poorer combustion process.

D) Pistons with a pot piston bowl and straight piston bowl walls. The cylinder base is configured so that a squish flow arises in the radial direction between the piston rim and cylinder head. Furthermore the torsional flow in the cylindrical pot piston bowl is intensified.

Pistons with pot piston bowls are very well suited for engines with torsional inlet channels and chamber spark plugs. During the compression stroke the mixture is compressed over the piston base rim (squish edge) of the piston into the pot piston bowl. During the expansion stroke the mixture is sucked out again from the pot piston bowl. This process leads to strong squish flows, particularly in the vicinity of the upper dead centre point.

In addition to the squish flow the pot piston bowl also leads to an acceleration in the torsional flow generated on the inlet side. As a result of maintaining the angular momentum the rotational speed of the torsional flow increases when the mixture is compressed inwards into the pot piston bowl.

So that a strong squish flow can be produced the opening cross-section A of the piston base bowl should be as small as possible. This requirement however leads to deep bowls which for reasons of strength and space can only be implemented with difficulty.

A piston bowl may be designed so that a squish flow is converted to the highest extent possible into turbulence. In the case of gas engines with external mixture formation the influencing factors in this respect were however not known. The edges known in the prior art around the rim of the piston bowl may protrude too far however. Therefore they become relatively hot which particularly in the case of gas engines can lead to premature ignitions. A continuous path of the surface of the flow cut-off edge may be hereby provided which ensures adequate cooling thereof.

The present disclosure is directed, at least in part, to improving or overcoming one or more aspects of the prior systems.

### SUMMARY OF THE DISCLOSURE

In one aspect the present disclosure is directed to a piston of an internal combustion engine. The piston may comprise a piston sleeve with a centre axis M and a piston base with a diameter D delimiting the piston sleeve at the top. The piston base may be formed from a piston base rim of a width b and a piston bowl with a depth t. The piston bowl may be designed as a pot bowl and may have a piston bowl base as well as a piston bowl wall with a diameter d4 adjoining same. The piston bowl may have an opening cross-section A which is aligned symmetrically relative to the centre axis M and having a diameter da which may be smaller than the diameter d4. Through the reduced diameter da a flow cut-off edge designed as a nose may be formed in the region of the opening cross-section A. The nose may project inwards radially over the piston bowl wall (4). A transition between the piston base rim and the flow cut-off edge may be formed by a radius Ro and the flow cut-off edge may have inside a boundary zone g between the nose and the piston bowl wall a radius Ru. A tangential transition may be provided between the radius Ro and the radius Ru.

In another aspect the present disclosure is directed to a use of a piston for an Otto engine with, for example, an external mixture formation. The used piston may comprise a piston sleeve with a centre axis M and a piston base with a diameter D delimiting the piston sleeve at the top. The piston base may be formed from a piston base rim of width b and a piston bowl with a depth t. The piston bowl may be designed as a pot bowl and may have a piston bowl base as well as a piston bowl wall with a diameter d4 adjoining same. The piston bowl may include an opening cross-section A which is aligned symmetrically relative to the centre axis M and may have a diameter da which is smaller than the diameter d4. And through the reduced diameter da a flow cut-off edge designed as a nose may be formed in the region of the opening cross-section A. The nose may project inwards radially over the piston bowl wall.

Other features and aspects of this disclosure will be apparent from the following description and the accompanying drawings.

### BRIEF DESCRIPTION OF THE DRAWINGS

Further advantages and details of the present disclosure are explained in the description and are shown in the drawings. In the drawings:

FIG. 1 shows a partial sectional view of the piston with piston bowl;

FIG. 2 shows a sectional view of an alternative embodiment;

FIG. 3 shows a schematic diagram of an engine block.

### DETAILED DESCRIPTION

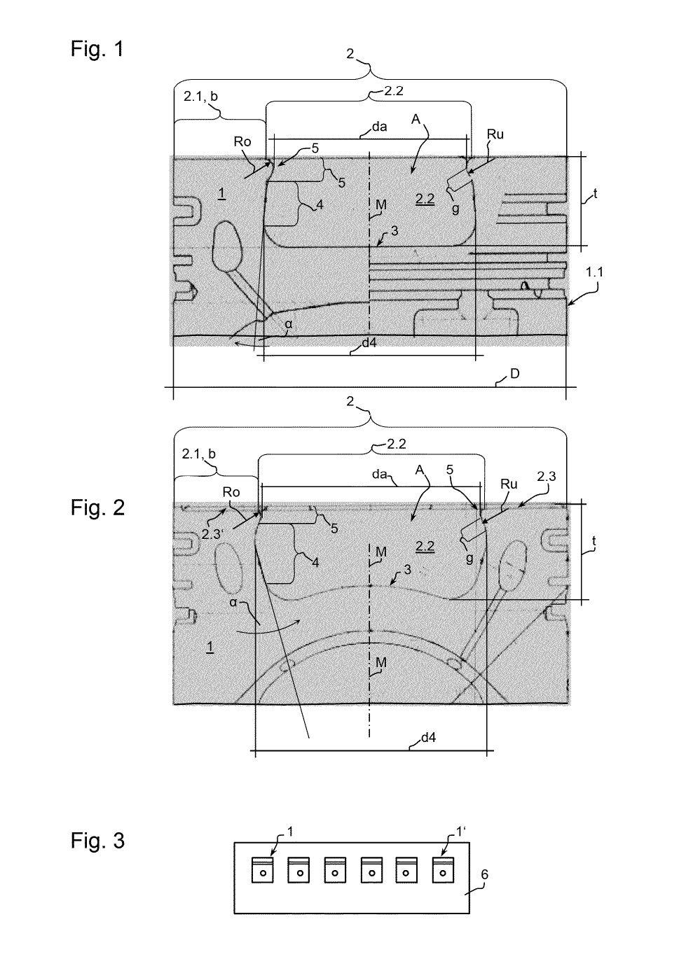

A piston 1 illustrated in FIG. 1 has a piston sleeve 1.1 and a piston base 2 delimiting the piston sleeve 1.1 at the top and having a piston diameter D wherein the piston base 2 is formed from a piston base rim 2.1 and a piston bowl 2.2 adjoining the piston base rim 2.1 on the inside. Both the piston bowl 2.2 and the piston base rim 2.1 are aligned coaxially with a centre axis M of the piston 1.

The piston bowl 2.2 has a depth t and an opening cross-section A with a diameter da. The piston bowl 2.2 or a piston bowl wall 4 has a slightly enlarged diameter d4 so that, starting from the opening cross-section A, a circumferential flow cut-off edge 5 is formed.

The piston bowl 2.2 is thus formed from the flow cut-off edge 5, the piston bowl wall 4 adjoining the flow cut-off edge 5, as well as the piston bowl base 3 which adjoins the piston bowl wall 4.

The flow cut-off edge 5 has in the transition area to the piston base rim 2.1 an upper radius Ro of 3 mm. Down towards the bottom, inside a boundary zone g between the flow cut-off edge 5 and the piston bowl wall 4 the flow cut-off edge 5 is defined by a lower radius Ru of about 10 mm.

The piston bowl wall 4 is with regard to the centre axis M at an angle α of about 5 degrees. The piston bowl wall 4 or the diameter d4 thereof increases, starting from the opening cross section A, continuously downwards and has at the bottom end the said diameter d4.

The ratio of Ro to D amounts roughly to 0.02. The ratio of Ru to D amounts roughly to 0.1. The ratio of da to d4 amounts roughly to 0.9.

According to the embodiment of FIG. 2 the position of the piston bowl wall 4 is positive, i.e. the piston bowl wall 4 or the diameter d4 thereof tapers, starting from the opening cross-section A. The angle α between the piston bowl wall 4 and the centre axis M is also substantially larger and amounts to about 15 degrees.

Through the design of the flow cut-off edge 5 described above, a width b of the piston rim 2.1 is formed so as to be slightly larger than in the case where such a flow cut-off edge 5 is not present. This in turn substantiates a somewhat increased squish flow between the area above the piston base rim 2.1 and the piston bowl 2.2 with the up and down movement of the piston 1 in the cylinder. The squish flow is according to the embodiment of FIG. 2 slightly influenced by valve pockets 2.3, 2.3′ in the piston base rim 2.1.

FIG. 3 shows schematically an engine block 6 with several pistons 1, 1′ contained therein according to one of the embodiments according to FIGS. 1 and 2.

### INDUSTRIAL APPLICABILITY

A piston according to the present disclosure may be provided with a specifically designed piston base for an engine so that an improved combustion may be achieved. Particularly in the case of an Otto engine or an Otto-based gas engine premature ignition due to the flow cut-off edge being too hot, and thus knocking of the engine, may be prevented.

At the cut-off edge of the present piston a definite flow cut-off takes place which may increase the turbulence in the combustion chamber. The increased turbulence leads to an accelerated combustion and to a faster and better burn-off in the piston bowl. The degree of efficiency and the knocking interval of the engine may be thereby increased. Indeed the formation of the cut-off edge may involve an enlarged diameter dm of the piston bowl with a constant width b of the piston base rim so that with a constant volume of the piston bowl the depth t of the piston bowl can be reduced. The diameter D of the piston base thereby may correspond to the piston diameter. The piston diameter likewise may correspond to the diameter da of the opening cross-section A of the piston bowl plus double the width b of the piston base rim.

According to an exemplary embodiment of the present disclosure the ratio of the diameter da of the opening cross-section A to the diameter D of the piston base or the piston diameter preferably fulfils the following condition: d/D=0.4-0.6.

According to another exemplary embodiment of the present disclosure the ratio of the depth t of the piston bowl to the diameter D of the piston base or the piston diameter preferably fulfils the following condition: t/D=0.15-0.35.

According to a further exemplary embodiment of the present disclosure the piston bowl may have an opening cross-section A which is aligned symmetrically or coaxially with the centre axis M and which has a diameter da which is smaller than the diameter d4 and through the reduced diameter da a flow cut-off edge designed as a nose is formed in the area of the opening cross-section A wherein the nose protrudes inwards radially over the piston bowl wall for an Otto engine with external mixture formation. According to the prior art the flow cut-off edge was provided in order to improve the mixing of the injected diesel with the combustion air. In the case of a gas engine with external mixture formation this mixing of fuel and combustion air ma be no longer necessary. A flow cut-off edge, as described in the prior art for diesel engines, is thus not necessary for a gas engine with external mixture formation.

When using such a piston for a gas engine with external mixture formation it can likewise be advantageous if a transition is formed between the piston base rim and the flow cut-off edge by a radius Ro and the flow cut-off edge has inside a boundary zone g between the nose and the piston bowl wall a radius Ru wherein a tangential transition is provided between the radius Ro and the radius Ru.

It might be advantageous in the case of an engine, as also during use, if the piston bowl wall includes with the centre axis M an angle α wherein the angle α over at least 50% of the depth t of the piston bowl

a) for a piston bowl widening out towards the piston bowl base is no greater than 4° to 7° or

b) for a piston bowl tapering towards the piston bowl base (3) is no smaller than 13° to 17°. The piston bowl is pot-like, i.e. designed with a relatively steep piston bowl wall so that the desired turbulences can indeed be reached. A tumble flow, as may be favoured by flat piston bowls, should however be directly counteracted. Rather a flatter position of the piston bowl wall as a result of a fuel jet injection direction is also not required because the piston is designed for an Otto engine with external mixture formation.

Furthermore it might be advantageous if the ratio of the radius Ru to the diameter D fulfils the following condition: W1<=Ru/D<=W2, with 0.04<=W1<=0.06 or W1=0.05 and 0.19<=W2<=0.21 or W2=0.2. The radius Ru should not be too large so that a definite flow cut-off arises. The radius Ru should also not be too small so that the flow cut-off edge does not become too hot.

It can also be advantageous if in the area of the piston bowl wall between 3 mm to 10 mm or between 0.02 D and 0.05 D below the radius da the diameter d4 is greater by an amount M1 than the diameter da, with 2 mm<=M1<=6 mm or 0.01 D<=M1<=0.05 D. This ensures in turn a sufficiently large gradient for the flow deflection for the purpose of introducing an adequate amount of turbulence.

It can also be of importance for the present disclosure if the ratio of the radius Ro to the diameter D fulfils the following condition: W3<=Ro/D<=W4, with 0.005<=W3<=0.015 or W3=0.01 and 0.02<=W4<=0.04 or W4=0.03. The radius Ro should sufficiently assist the squish flow which changes between the piston bowl and the piston base rim. The radius Ro should not be too great so that a definite flow cut-off occurs. The radius Ro should also not be too small so that the flow cut-off edge does not become too hot.

In conjunction with the design and arrangement according to the present disclosure it can be advantageous if the ratio of the diameter da to the diameter d4 fulfils the following condition:

W5<=da/d4<=W6,

with 0.7<=W5<=0.9 or W5=0.8 and 0.9<=W6<=1.0 or W6=0.98.

The narrowing of the opening of the piston bowl should be sufficiently large so that a sufficiently large gradient is guaranteed for the flow deflection.

The problem is also solved by an engine block of an Otto engine having internal or external mixture formation with a piston guided therein, as described above. The knocking of the Otto engine is prevented by avoiding a too hot flow cut-off edge.

1. A piston of an internal combustion engine, comprising:
a piston sleeve with a centre axis; and
a piston base with a diameter D delimiting the piston sleeve at the top,
wherein the piston base includes a piston base rim of a width b and a piston bowl with a depth t;
wherein the piston bowl is designed as a pot bowl and has a piston bowl base and a piston bowl wall with a diameter d4 adjoining the piston bowl base, the piston bowl having an opening cross-section which is aligned symmetrically relative to the centre axis, the cross-section having a diameter da which is smaller than the diameter d4;
wherein a flow cut-off edge having the diameter da and designed as a nose is formed in the opening cross-section, wherein the nose projects inwards radially over the piston bowl wall; and
wherein a first transition wall between the piston base rim and the flow cut-off edge is formed by has a radius Ro and the flow cut-off edge has a second transition wall in a boundary zone g disposed between the nose and the piston bowl wall, the second transition wall having a radius Ru wherein a tangential transition is provided between the radius Ro and the radius Ru.

2. The piston according to claim 1, wherein the piston bowl wall is disposed at an angle α with the centre axis, wherein
a) for a piston bowl widening out towards the piston bowl base, the angle α is no greater than 4° to 7° over at least 50% of the depth t of the piston bowl, and
b) for a piston bowl tapering towards the piston bowl base, the angle α is no smaller than 13° to 17° over at least 50% of the depth t of the piston bowl.

3. The piston according to claim 1, wherein the ratio of the radius Ru to the diameter D fulfils the following condition:
W1<=Ru/D<=W2 with 0.04<=W1<=0.06 and 0.19<=W2<=0.21.

4. The piston according to claim 1, wherein in the region of the piston bowl wall between 0.02 D and 0.05 D below the flow cut-off edge, the diameter d4 is greater than the diameter da by an amount M1, with 0.01 D<=M1<=0.05 D.

5. The piston according to claim 1, wherein the ratio of the radius Ro to the diameter D fulfils the following condition:
W3<=Ro/D<=W4, with 0.005<=W3<=0.015 and 0.02<=W4<=0.04.

6. The piston according to claim 1, wherein the ratio of the diameter da to the diameter d4 fulfils the following condition:
W5<=da/d4<=W6, with 0.7<=W5<=0.9 and 0.9<=W6<<=1.0.

7. An Otto engine comprising:
a piston, including:
a piston sleeve with a centre axis; and;
a piston base with a diameter D delimiting the piston sleeve at the top,
wherein the piston base includes a piston base rim of a width b and a piston bowl with a depth t;
wherein the piston bowl is designed as a pot bowl and has a piston bowl base and a piston bowl wall with a diameter d4 adjoining the piston bowl base, the piston bowl having an opening cross-section which is aligned symmetrically relative to the centre axis, the cross-section having a diameter da which is smaller than the diameter d4;
wherein a flow cut-off edge designed as a nose is formed in the opening cross-section, the flow cut-off edge having the diameter da, wherein the nose projects inwards radially over the piston bowl wall; and
wherein a first transition wall between the piston base rim and the flow cut-off edge has a radius Ro and the flow cut-off edge has a second transition wall in a boundary zone g disposed between the nose and the piston bowl wall, the second transition wall having a radius Ru wherein a tangential transition is provided between the radius Ro and the radius Ru.

8. A piston for an Otto engine with external mixture formation, the piston having:
a piston sleeve with a centre axis; and
a piston base with a diameter D delimiting the piston sleeve at a top,
wherein the piston base includes a piston base rim of width b and a piston bowl with a depth t,
wherein the piston bowl is designed as a pot bowl and has a piston bowl base and a piston bowl wall with a diameter d4 adjoining the piston bowl base, and the piston bowl has an opening cross-section which is aligned symmetrically relative to the centre axis and has a diameter da which is smaller than the diameter d4,
wherein a flow cut-off edge designed as a nose is formed in the opening cross-section, wherein the nose projects inwards radially over the piston bowl wall.

9. The piston according to claim 8, wherein a first transition wall between the piston base rim and the flow cut-off edge has a radius Ro and the flow cut-off edge has a second transition wall in a boundary zone g disposed between the nose and the piston bowl wall, the second transition wall having a radius Ru wherein a tangential transition is provided between the radius Ro and the radius Ru

10. The piston according to claim 8, wherein the piston bowl wall is disposed at an angle α with the centre axis wherein
c) for a piston bowl widening out towards the piston bowl base, the angle α is no greater than 4° to 7° over at least 50% of the depth t of the piston bowl; and
d) for a piston bowl tapering towards the piston bowl base, the angle α is no smaller than 13° to 17° over at least 50% of the depth t of the piston bowl.

11. The piston according to claim 8, wherein the ratio of the radius Ru to the diameter D fulfils the following condition:
W1<=Ru/D<=W2 with 0.04<=W1<=0.06 and 0.19<=W2<=0.21.

12. The piston according to claim 8, wherein the ratio of the radius Ru to the diameter D fulfils the following condition:
W1<=Ru/D<=W2 with 0.04<=W1<=0.06 and 0.19<=W2<=0.21.

13. The piston according to claim 8, wherein in the region of the piston bowl wall between 0.02 D and 0.05 D below the flow cut-off edge, the diameter d4 is greater than the diameter da by an amount M1, with 0.01 D<=M1<=0.05 D.

14. The piston according to claim 8, wherein the ratio of the radius Ro to the diameter D fulfils the following condition:
W3<=Ro/D<=W4, with 0.005<=W3<=0.015 and 0.02<=W4<=0.04.

15. The piston according to claim 8, wherein the ratio of the diameter da to the diameter d4 fulfils the following condition:
W5<=da/d4<=W6, with 0.7<=W5<=0.9 and 0.9<=W6<=1.0.

16. The Otto engine according to claim 7, wherein the piston bowl wall is disposed at an angle α with the centre axis wherein
a) for a piston bowl widening out towards the piston bowl base, the angle α is no greater than 4° to 7° over at least 50% of the depth t of the piston bowl, and
b) for a piston bowl tapering towards the piston bowl base, the angle α is no smaller than 13° to 17° over at least 50% of the depth t of the piston bowl.

17. The Otto engine according to claim 7, wherein the ratio of the radius Ru to the diameter D fulfils the following condition:
W1<=Ru/D<=W2 with 0.04<=W1<=0.06 and 0.19<=W2<=0.21.

18. The Otto engine according to claim 7, wherein in the region of the piston bowl wall between 0.02 D and 0.05 D below the flow cut-off edge, the diameter d4 is greater than the diameter da by an amount M1, with 0.01 D<=M1<=0.05 D.

19. The Otto engine according to claim 7, wherein the ratio of the radius Ro to the diameter D fulfils the following condition:
W3<=Ro/D<=W4, with 0.005<=W3<=0.015 and 0.02<=W4<=0.04.

20. The Otto engine according to claim 7, wherein the ratio of the diameter da to the diameter d4 fulfils the following condition:
W5<=da/d4<=W6, with 0.7<=W5<=0.9 and 0.9<=W6<=1.0.
